(19) United States
(12) Patent Application Publication
(10) Pub. No.: US 2006/0159467 A1
(43) Pub. Date: Jul. 20, 2006

(54) Image forming device

(75) Inventor: Shigeyuki Takahashi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/280,257

(22) Filed: Nov. 17, 2005

(30) Foreign Application Priority Data
Nov. 19, 2004 (JP) 2004-336314

(51) Int. Cl. G03G 15/00; G03G 15/01

(52) U.S. Cl. 399/12; 399/13; 399/227

(57) ABSTRACT

An image forming device is provided in which a plurality of toner cartridges can be installed, and with which toner cartridges appropriate to the startup mode of the device can reliably be installed, so that it is possible to perform printing correctly in that mode. The image forming device to which development units containing toner are removably installed, and which performs image forming using the toner, can operate in a plurality of startup modes, in each of which a respective installation condition for the development units, according to at least the toner colors and numbers of the installed development units, is determined; and the image forming device includes a control unit which outputs a command to display a message to a user, if the installation condition for the development units which is determined for the set startup mode, and the installation state of the installed development units, are different.

### BACKGROUND OF THE INVENTION

1. Field of the Invention

The present invention relates to an image forming device such as a printer, a facsimile, a photocopier or the like which forms images using an electrophotographic technology, and more particularly, relates to an image forming device which can perform printing reliably in the mode which is set.

2. Description of the Related Art

Generally, with an image forming device such as a printer, a facsimile, a photocopier or the like which creates images using an electrophotographic technology, image forming is performed by creating an electrostatic latent image according to image data, supplying a toner which is a developer to this electrostatic latent image so as to develop a toner image, and transferring this toner image to the medium which is to be the object of transfer. With this type of device, the toner cartridge which contains the above described toner is made so as to be installed in a removable manner; and, normally, a toner cartridge containing black toner is installed to a device which performs image forming in monochrome, while one each of toner cartridges containing toners of a plurality of colors (for example four color toner cartridges containing yellow Y, magenta M, cyan C, and black K) are installed to a device which performs image forming in color.

Among these types of prior art image forming device, there are devices which are dedicated only to monochrome printing and ones which are dedicated only to color printing, and there are also devices which are capable of printing both in monochrome and in color. And, with the latter type of device which is capable of printing both in monochrome and in color, there are provided both a startup mode for performing monochrome printing and a startup mode for performing color printing, and printing operation is performed according to the mode which is set by the user. Although in this manner the user is able to change over between the modes which he uses according to the service he requires, as described above, with such a prior art device, normally, it is arranged for the toner cartridges of the various colors required to be installed one at a time.

On the other hand, in Japanese Patent Laid-Open Publication 2002-351190, there is proposed an image forming device to which a plurality of toner cartridges of the same color are installed, and an advantageous effect is disclosed when performing a large quantity of development with one color.

With the above described prior art device which is capable of changing over between modes, when the device is to be used in its color printing mode, toner cartridges of the various required colors, for example of the colors Y, M, C, and K, are installed one at a time in positions determined in advance, and thereby it becomes possible to perform printing. In other words, the positions in which the toner cartridges are to be installed are determined for each color, and the construction is such that it is not possible to install them in other positions. Furthermore, even when the printer is to be used in the monochrome mode, just one of the black (K) toner cartridge to be used is installed in its predetermined position, and thereby it becomes possible to perform printing. Accordingly, the situation is such that toner cartridge installation mistakes, such as mistakenly installing a toner cartridge of a different color or the like, cannot easily occur. Due to this, with this type of prior art device, exceptional measures have not been taken with regard to installation mistakes for toner cartridges.

Moreover if, for example, with a device which can be used both in the color mode and the monochrome mode, it is possible to install a plurality of toner cartridges of the same color, as proposed in the above described patent document, then it has been considered to make it possible to install a plurality of black (K) toner cartridges during the monochrome mode. And, in this case, in order to keep the locations for installation of toner cartridges in this device to a minimum, a structure is appropriate in which it is made possible to install a K toner cartridge in the locations in which, during the color mode, the Y, M, and C toner cartridges are installed. With this type of device, on the one hand the freedom for installation of the toner cartridges is enhanced, but, since it is possible to install a K toner cartridge in any position, the possibility becomes high that the installation of the toner cartridges will be undesirably performed in a manner which is not suitable for the mode which is currently set. And no proposals have been made in the prior art with regard to countermeasures against toner cartridge installation mistakes in this sort of case.

### SUMMARY OF THE INVENTION

Thus, an object of the present invention is to provide an image forming device in which a plurality of toner cartridges may be installed, to which toner cartridges appropriate to the startup mode of the device can reliably be installed, so that printing may be correctly performed in that mode.

In order to achieve the above described object, one aspect of the present invention is an image forming device to which development units containing toner are removably installed, and which performs image forming using the toner contained in the development units, which can operate in a plurality of startup modes, in each of which a respective installation condition for the development units, according to at least the toner colors and numbers of the development units which are installed, is determined, and including a control unit which outputs a command to display a message to a user of the image forming device, if the installation condition for the development units which is determined for the startup mode which is set, and the installation state of the development units which are installed, are different. Thus, according to the present invention, since the message is displayed if the installation state of the development units does not correspond to the startup mode which is set at this time point, accordingly the user is prompted to exchange the development units or the like so as to bring about the correct installation state, and it is possible to prevent printing being performed in a mistaken state, which would be undesirable. In other words, the situation is brought about in which the development units which are appropriate to the startup mode of the device are installed, so that printing may be performed reliably.

Furthermore, with the present invention, a desirable aspect thereof is characterized in that the image forming device comprises a display portion, and the display portion displays the message according to the display command.

Moreover, with the present invention, a desirable aspect thereof is characterized in that the message to the user prompts the user to perform a task to be performed by the user with regard to attachment or removal of the development units. By this, it is possible for the user to perform the task for bringing about the state which is appropriate to the startup mode in a simple manner.

Still further, with the present invention, a desirable aspect thereof is characterized in that, if the installation condition for the development units and the installation state thereof are different, an installation location of the development unit for which the task is to be performed by the user is shifted to an exchange position of the development unit. By this, it is possible for the user to perform the task for bringing about the state which is appropriate to the startup mode in an even simpler manner. Moreover, it is possible to prevent errors in this task.

Even further, with the present invention, a desirable aspect thereof is characterized in that, if the installation condition for the development units and the installation state thereof are different, the image forming procedure is not performed. Accordingly, it is possible to prevent printing being mistakenly performed with an installation state of the development units which is not in conformity with the startup mode, which would be undesirable.

Yet further, with the present invention, a desirable aspect thereof is characterized by having such a startup mode, in which the installation condition is that a plurality of the development units containing black toner are installed.

Furthermore, another aspect of the present invention is characterized by having: the startup mode in which the installation condition is that one each of the development units, respectively containing toner of one of a plurality of colors used for the image forming in color, is installed; the startup mode in which the installation condition is that a plurality of the development units containing black toner are installed; and the startup mode in which the installation condition is that one of the development units which contains black toner is installed.

Yet further objectives and features of the present invention will become apparent from the preferred embodiment of the present invention explained hereinafter.

### BRIEF DESCRIPTION OF THE DRAWINGS

FIG. 1 is a structural diagram of an embodiment of an image forming device to which the present invention has been applied;

FIG. 2 is a structural diagram showing mainly the mechanism of an engine 6 of this printer 2;

FIG. 3 is a figure showing examples of a display panel 71 and an operation panel 72 of an operation unit 7;

FIG. 4 is a flowchart showing an example of a toner cartridge installation state checking procedure;

FIGS. 5A-5C are drawings showing examples of messages which are displayed;

FIG. 6 is a flow chart showing an example of the processing details in a step S20;

FIG. 7 is a flow chart showing an example of the processing details in a step S30; and

FIG. 8 is a flow chart showing an example of the processing details in a step S40.

### DESCRIPTION OF THE PREFERRED EMBODIMENT

In the following, an embodiment of the present invention will be explained with reference to the figures. However, this embodiment is not one which is limitative of the technical range of the present invention. Moreover it should be understood that, in the figures, to elements which are the same or similar, the same reference numbers or symbols are appended.

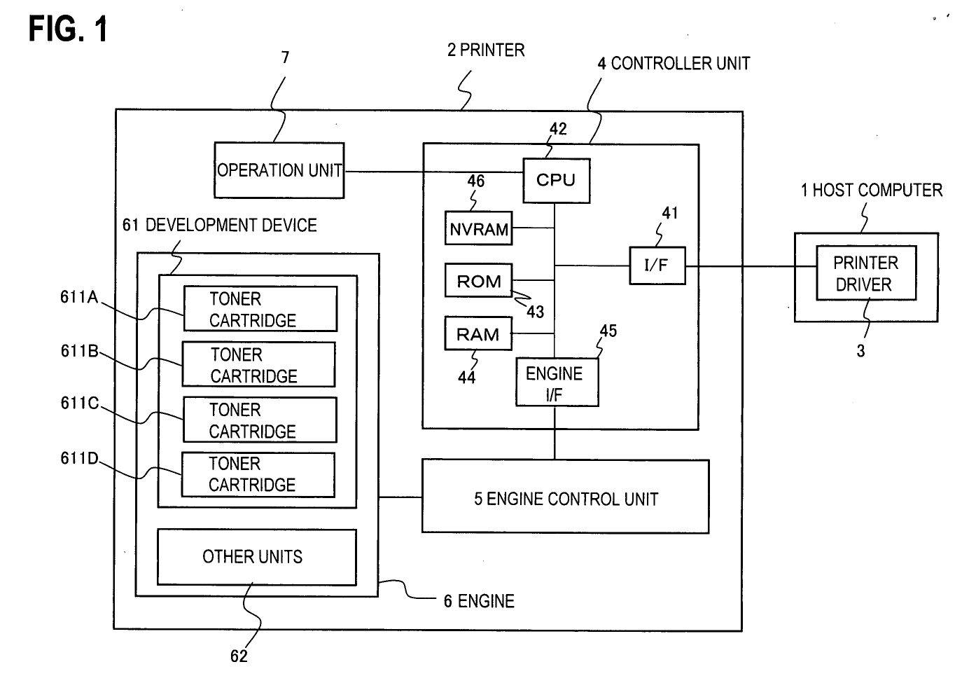

FIG. 1 is a structural diagram of an embodiment of a printer, which is an image forming device to which the present invention has been applied. The printer 2 shown in FIG. 1 is an image forming device to which the present invention has been applied, and it is a device which performs image forming upon a predetermined printing medium (paper) based upon a printing request from a host computer 1, or the like. This printer 2 is one which is built so as to have a plurality of startup modes, and, as appropriate, it checks the conformity of the startup mode which is set and the toner cartridges 611 (development units) which are installed, and, if non-conformity is apparent, it displays a message to that effect to the user; so that it may reliably perform correct printing with the appropriate toner cartridges 611.

The host computer 1 shown in FIG. 1 is a host device which issues printing requests to the printer 2, and it transmits printing data including image data and control commands to the printer 2, based upon operation by the user or the like. It should be understood that this host computer 1 may consist of a so-called personal computer or the like. A printer driver 3 within the host computer 1 receives data from an application within the host computer 1 (not shown in the figures) or the like, and generates the above described printing data and transmits it to the printer 2. It should be understood that this printer driver 3 is a program which causes the host computer 1 to perform processing related to the above described function, so that the above described function is attained by a control device (not shown in the figures) of the host computer 1 performing processing according to the program.

Next, as shown in FIG. 1, the printer 2 comprises a controller unit 4, an engine control unit 5, an engine 6, an operation unit 7, and the like; it is a so-called four-cycle laser printer. With this printer 2, there are three startup modes: a Color mode, a BW4 mode, and a BW1 mode.

The Color mode is a mode for performing color printing, and it is a mode in which one toner cartridge 611 for each of Y, M, C, and K is installed in its respectively determined location in a development device 61 which will be described hereinafter. Furthermore, the BW4 mode is a mode for performing monochrome printing, and it is a mode in which K toner cartridges 611 are installed in all the (four) installation locations of the development device 61. Moreover, the BW1 mode is a mode for performing monochrome printing, and, in this mode, one K toner cartridge 611 is installed in a predetermined location.

And the structure is so made that it is possible to install only a K toner cartridge 611 in any installation location of the development device 61, in order to make it possible for it to be used in these modes.

The controller unit 4 receives the printing data which is transferred from the host computer 1, and, along with interpreting the control commands included in the data, also performs predetermined processing upon the image data included in the data and generates data for supply to the side of the engine 6. As shown in FIG. 1, this controller unit 4 comprises an I/F 41, a CPU 42 (i.e. a control unit), a ROM 43, a RAM 44, an engine I/F 45, and a NVRAM 46.

The I/F 41 is a section which receives the printing data which is transmitted from the host computer 1, while the ROM 43 is a section which stores various programs for controlling this printer 2. And the RAM 44 is a memory which stores the printing data which has been received or the like, and the image data for each page upon which the printing procedure is to be performed by the engine 6 is transferred from here to the engine I/F 45. Moreover, the NVRAM 46 is a non-volatile memory, and, it stores information which should remain and be not deleted even when the power source for this printer 2 is turned OFF. For example, information such as which one of the three startup modes described above is set, and the like, is stored therein.

The CPU 42 is a section which controls various types of procedure executed by this printer 2, and, in particular, it is in charge of the procedure of storing in the RAM 44 the image data included in the printing data which has been received, the procedure of interpreting the control commands included in the printing data and commanding the engine control unit 5 to perform appropriate printing procedures, the procedure of controlling the operation unit 7 to provide an interface with the user, and the like. This printer 2 is particularly distinguished by the characteristic that, when its power source is turned on or the like, the CPU 42 performs a checking procedure for the installation state of the toner cartridges 611 or the like; the concrete details there of will be described herein after. It should be understood that, principally, the procedures and so on which are executed by the CPU 42 are performed according to programs which are stored in the ROM 43.

Next, the engine I/F 45 is a section which, during the operation of printing by the engine 6, reads out pixel data stored in the previously described RAM 44 at a predetermined timing, and transfers this data to the side of the engine 6 after having performed predetermined procedures thereupon; thus, it is in charge of the interface between the controller unit 4 and the side of the engine 6. It should be understood that a memory which stores data temporarily, a decompressing unit, a screen processing unit, and the like are comprised within this engine I/F 45, although these elements are not shown in the figures; and these perform decompression of compressed data in the picture element data which has been read out from the RAM 44, and screen processing for converting it to dot data and the like. Moreover, in concrete terms, this engine I/F 45 may be embodied as an ASIC.

Next, the engine control unit 5 comprises a CPU, a ROM, a RAM, and the like, although these elements are not shown in the figures; and it controls the movement of the various portions of the engine 6, as will be explained hereinafter. It should be understood that, when the CPU 42 is performing a check of the installation state of the toner cartridges 611 as described above, along with information for each location of the development device 61 about the presence or absence of a toner cartridge 611 and about the color of the toner cartridge 611 which is installed being notified to the controller unit 4, control is performed according to commands from the controller unit 4, in order to perform control to shift the installation location of a predetermined toner cartridge 611 of the development device 61 to an exchange position, by this control unit 5.

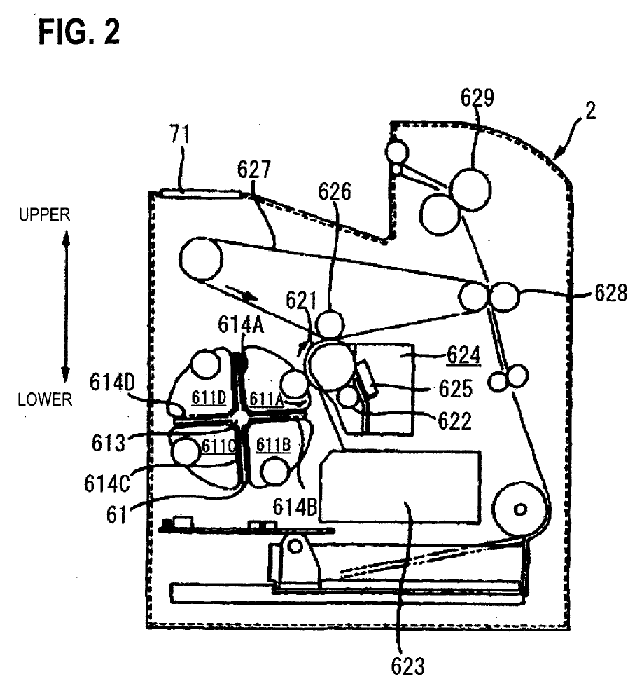

Next, although the engine 6 comprises an electrification unit, an exposure unit, a development device, a transfer unit, and the like, in FIG. 1, it is represented as being divided into the development device 61 and other units 62. FIG. 2 is a structural view focusing on a portion of the mechanism of the engine 6 of this printer 2. A photosensitive drum 621 comprises an electrically conductive main member shaped as a circular cylinder and a photosensitive layer formed upon the outer peripheral surface of this main member, and is capable of rotating around its central axis, rotating in the clockwise direction as shown by the arrow sign in the figure. An electrification unit 622 electrifies this photosensitive drum 621, and an exposure unit 623 forms a latent image with static electricity by irradiating a beam from a light source such as an internally housed laser or LED array or the like upon the photosensitive drum 621 which has been thus electrified. This beam irradiation by the exposure unit 623 is controlled by a drive signal which is modulated based upon the image information inputted from the host computer 1.

The development device 61 comprises installation units 614A through 614D in which toner cartridges 611A through 611D containing toner, which is a development material, are installed in a removable manner, and thereby there is constituted a rotary development device which can rotate about its central shaft 613. The development device 61 is rotated so that the one of the toner cartridges 611A through 611D which is required to be used is brought to be positioned next to the photosensitive drum 621, and, by the development material being supplied onto the photosensitive drum 621 upon which a latent image has been formed, that latent image is developed with the development material into an image.

It should be understood that, in the installation units 614A through 614D of the development device 61, according to the three startup modes previously described, toner cartridges 611A through 611D containing development material of the colors Y, M, C, and K respectively maybe installed, or toner cartridges 611A through 611D all containing K toner may be installed. Furthermore, as previously described, the installation locations for the Y, M, and C toner cartridges 611 are fixed as being, respectively, the installation units 614A through 614C. Moreover, in the BW1 mode, a K toner cartridge 611 is installed in the installation unit 614D. It should be understood that the letters A through D which are appended to the toner cartridges 611A through 611D and so on, are symbols for identifying the installation positions for these toner cartridges 611 in the development device 61.

A primary transfer unit 626 transfers the toner image formed upon the photosensitive drum 621 to an intermediate transfer member 627. This intermediate transfer member 627 may be, for example, an endless belt comprising a PET film with an aluminum layer formed upon its surface by vapor deposition, and with a semiconductive coating formed upon its surface, and it is rotationally driven at the same peripheral speed as the photosensitive drum 621. And a secondary transfer unit 628 transfers the toner image which has been formed upon the intermediate transfer member 627 to a printing medium such as paper or the like, while a fixing unit 629 fixes the toner image which has been thus transferred to the printing medium onto the medium and makes it into a permanent image, with this printing medium then being ejected to the exterior of the printer 2.

A cleaning unit 624 is provided between the primary transfer unit 626 and the electrification unit 622, and comprises a cleaning blade 625 which contacts against the surface of the photosensitive drum 621, so that, after the primary transfer, the development material (toner) which remains upon the photosensitive drum 621 is removed by this cleaning blade 625.

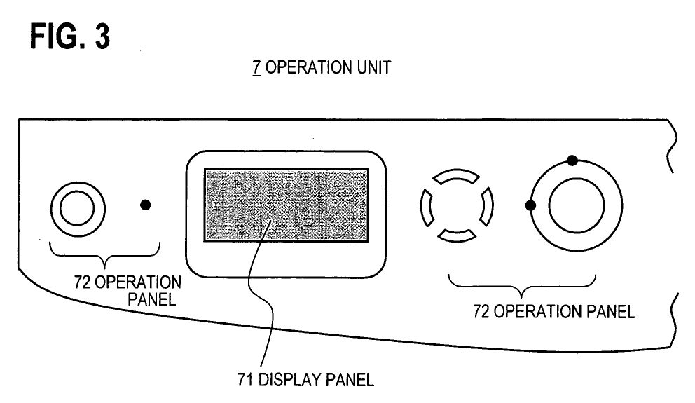

The operation unit 7 shown in FIG. 1 is a section for the user to operate the printer 2, and it comprises a display panel 71 (a display portion) and an operation panel 72 and so on. FIG. 3 is a figure showing an example of this display panel 71 and operation panel 72 of the operation unit 7. The display panel 71 shown in FIG. 3 consists of, for example, an LCD display or the like, and menus for operation and messages to the user and so on are displayed thereupon. Furthermore, as shown in FIG. 3, upon the operation panel 72, there are provided various types of buttons (switches) and lamps. With this type of operation unit 7, various types of operation are possible for the printer 2, such as setting of printing conditions and the like, and, moreover, error messages are displayed to the user, such as when some type of malfunction has occurred with the printer 2 or the like. With this printer 2, an error message is displayed if the installation state of the toner cartridge 611 is not appropriate for the startup mode, and this point is a great characteristic.

With the printer 2 according to this embodiment which has a structure like the one explained above, during printing, the printing data which has been written in a predetermined language is supplied from the host computer 1, an electrostatic latent image is formed upon the photosensitive drum 621, this image is developed with the corresponding toner cartridge 611, and transfer of the toner image to the intermediate transfer member 627 is performed by the primary transfer unit 626. And, furthermore, this image is transferred by the secondary transfer unit 628 to the printing medium such as paper or the like and is fixed by the fixing unit 629, and is then ejected to the exterior of the printer 2.

Although basically the printer 2 operates according to these details, with this printer 2, as previously mentioned, its distinguishing feature is the checking procedure for the installation state; in the following, these matters will be explained in concrete terms.

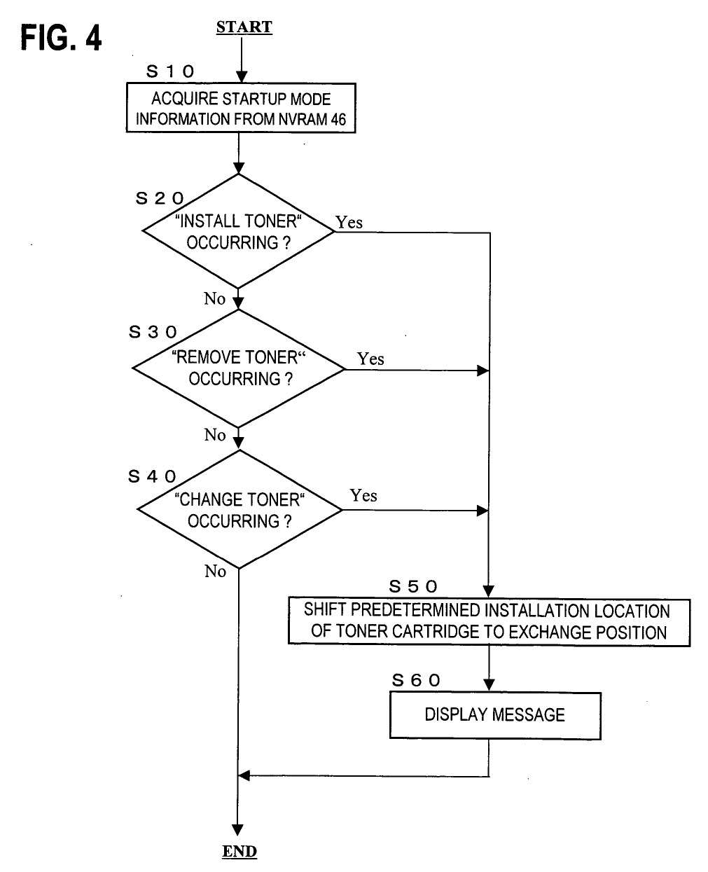

FIG. 4 is a flow chart showing an example of the installation state checking procedure for the toner cartridges 611 performed by the CPU 42. This installation state checking procedure for the toner cartridges 611 shown in FIG. 4 is performed when turning on of the power source of the printer 2 is performed, when setting of the startup mode is performed by the user, or when exchange of a toner cartridge 611 is performed or the like.

First, the CPU 42 accesses the previously described NVRAM 46, and acquires information about the startup mode that is set at this time point (in a step S10). As previously described, with this printer 2, there are provided the three startup modes—the Color mode, the BW4 mode, and the BW1 mode—and the CPU 42 comes to acquire information as to which of these modes is set at this time point.

Thereafter, the CPU 42 performs a procedure for checking whether or not “Install Toner” is occurring (in a step S20). Here by “‘Install Toner’ is occurring” is meant that a state currently holds in which it is necessary to install a further toner cartridge 611, in order to attain the installation state of the toner cartridges 611 which is appropriate to the startup mode which is set at this time point; or, to put it in another manner, it means that the error is currently occurring that the toner cartridges 611 which are installed are deficient. The concrete procedural details of this checking procedure will be described hereinafter.

And if the result of the check is that “Install Toner” is occurring (YES in the step S20), then the flow of control proceeds to a step S50. On the other hand, if “Install Toner” is not occurring (NO in the step S20), then a procedure for checking whether or not “Remove Toner” is occurring is performed (in a step S30). Here by “‘Remove Toner’ is occurring” is meant that a state currently holds in which it is necessary to remove a toner cartridge 611, in order to attain the installation state of the toner cartridges 611 which is appropriate to the startup mode which is set at this time point; or, to put it in another manner, it means that the error is currently occurring that a superfluous toner cartridge 611 is installed. The concrete procedural details of this checking procedure will be described hereinafter.

And if the result of the check is that “Remove Toner” is occurring (YES in the step S30), then the flow of control proceeds to the step S50. On the other hand, if “Remove Toner” is not occurring (NO in the step S30), then a procedure for checking whether or not “Change Toner” is occurring is performed (in a step S40). Here by “‘Change Toner’ is occurring” is meant that a state currently holds in which it is necessary to exchange a toner cartridge 611, in order to attain the installation state of the toner cartridges 611 which is appropriate to the startup mode which is set at this time point; or, to put it in another manner, it means that the error is currently occurring that an incorrect toner cartridge 611 is installed. The concrete procedural details of this checking procedure will be described hereinafter.

And, if the result of the check is that “Change Toner” is occurring (YES in the step S40), then the flow of control proceeds to the step S50. On the other hand, if “Change Toner” is not occurring (NO in the step S40), then the procedure terminates. In this case, since no error is occurring with regard to the installation state of the toner cartridges 611, in other words since the toner cartridges 611 which are installed are appropriate to the startup mode which is currently set, accordingly no error message is outputted to the user, and the state in which printing can be performed is entered.

On the other hand, if in any of the checks in the steps S20, S30, or S40 one of the errors described above has occurred, then the CPU 42 shifts the predetermined toner cartridge installation position to an exchange position for the toner cartridges 611 (in the step S50). In more concrete terms, the toner cartridge installation position which has been the cause of the occurrence of whichever one of the checked errors has actually occurred—in other words, if “Install Toner” is occurring, that toner cartridge installation position in to which it has been decided that a toner cartridge 611 must be installed, or, if “Remove Toner” is occurring, that toner cartridge installation position from which it has been decided that the toner cartridge 611 must be removed, or, if “Change Toner” is occurring, that toner cartridge installation position for which it has been decided that the toner cartridge 611 must be exchanged—is shifted to a predetermined position in which the user may perform exchange or installation or the like of the toner cartridge 611. This procedure is executed by the CPU 42 out putting a command to that effect to the engine control unit 5.

Next, since an error related to the installation of a toner cartridge 611 has occurred, the CPU 42 outputs a command to the operation unit 7 to display a guide message with regard to the action which the user must take, and this message is displayed upon the display panel 71 (in a step S60). In concrete terms, since an error related to the checking performed by one or the other of the steps S20, S30, or S40 is occurring, a message adapted to this error which has occurred is displayed.

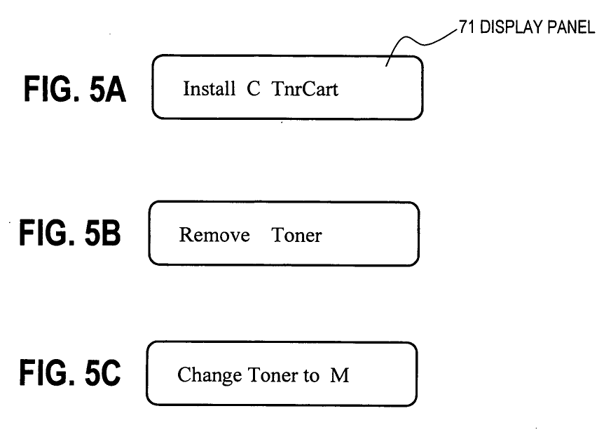

FIG. 5 is a figure showing examples of the messages which are displayed. FIG. 5A is a message which is displayed if the previously described “Install Toner” is occurring, and, in this example, it prompts the user to install a “C” toner cartridge. Upon this message, the user proceeds to install a C toner cartridge 611 in the toner cartridge installation location which is at the exchange position for the toner cartridges 611.

Furthermore, FIG. 5B is a message which is displayed if “Remove Toner” is occurring, and it prompts the user to remove the toner cartridge 611 at the exchange position for the toner cartridges 611. Furthermore, FIG. 5C is a message which is displayed if “Change Toner” is occurring, and it prompts the user to exchange the toner cartridge 611 at the exchange position for the toner cartridges 611 for a M toner cartridge 611.

In this manner, when an error message is displayed, the CPU 42 performs control so that printing operation cannot take place, since the startup mode which is currently set and the toner cartridges 611 which are installed are not in conformity with one another.

When the series of installation state checking procedures for the toner cartridges 611 described above have been completed, and display of a message has been performed (in the step S60), then, as described previously, the user performs attachment and/or removal of a toner cartridge 611 according to the message, and thereafter the installation state checking procedure for the toner cartridge 611 is again performed for a second time by the CPU 42. And if, finally, the installation state of the toner cartridges 611 is one which is appropriate for the startup mode which is currently set (NO in the step S40), then, at this time point, no installation state checking procedure for the toner cartridges 611 is performed by the CPU 42, but rather the system enters a state in which printing is possible.

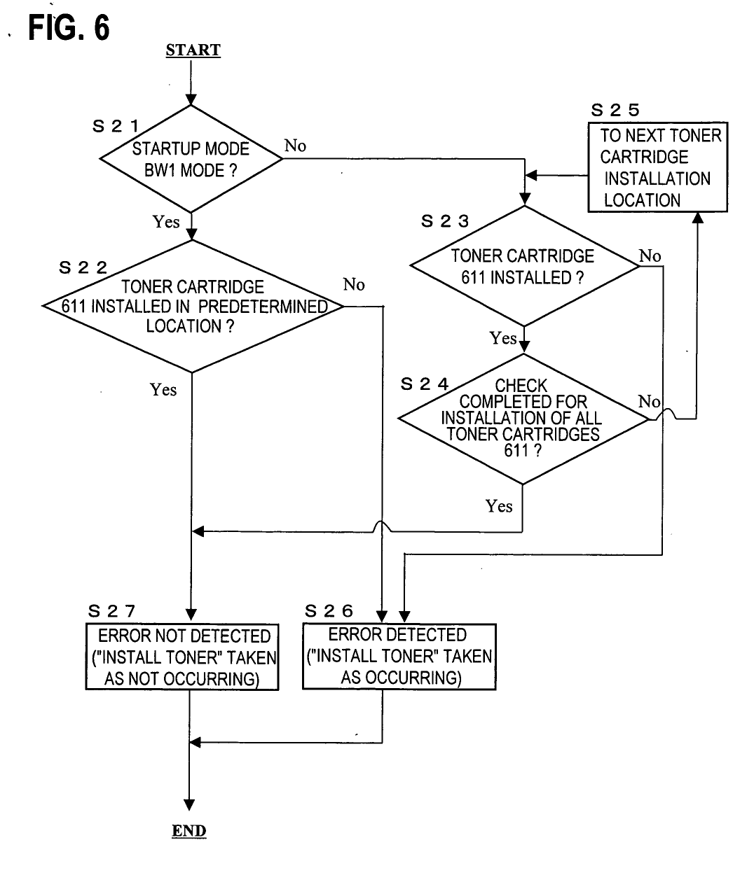

Next, the details of the procedures which are performed in the steps S20, S30, and S40 will each be explained in concrete terms. FIG. 6 is a flowchart showing an example of the processing details for the step S20. Here, the CPU 42 performs a check as to whether or not “Install Toner” is occurring, and, first, a decision is made as to whether the startup mode which is set at this time point is the BW1 mode or not (in a step S21). This decision is performed based upon the information which has been acquired in the step S10.

If the startup mode which is set is the BW1 mode (YES in the step S21), then the CPU 42 checks whether or not a toner cartridge 611 is installed in the predetermined location (in a step S22). In concrete terms, it checks whether a toner cartridge is installed in the previously described installation unit 614D. In this check, the CPU 42 queries the engine control unit 5 as to the presence or absence of the toner cartridge 611 in the appropriate installation unit 614. Upon receipt of this query, the engine control unit 5 makes a response to the query from the information about the installation state of the toner cartridges 611 at this time point which is stored in advance, or by acquiring information by accessing the engine 6. It should be understood that since, as previously described, in this embodiment, only a K toner cartridge 611 can be installed in the installation unit 614D, if a toner cartridge 611 is installed therein, then a toner cartridge 611 corresponding to the BW1 mode will come to be installed.

If the result of the check is that a toner cartridge 611 is installed in the installation unit 614D (YES in the step S22), then since, for the BW1 mode, it is not necessary to install any further toner cartridges 611 except for this one, it is considered (in a step S27) that no error related to “Install Toner” has been detected. In other words, it is considered that “Install Toner” is not occurring (NO in the step S20). On the other hand, if no toner cartridge 611 is installed in the installation unit 614D (NO in the step S22), then, since it is necessary to install a toner cartridge 611, an error related to “Install Toner” is considered to have been detected (in a step S26). In other words, “Install Toner” is considered to be occurring (YES in the step S20).

Furthermore if, in the step S21, the startup mode which is set is not the BW1 mode (NO in the step S21), then the CPU 42 checks in order (in the steps S23 and S25) whether or not toner cartridges 611 are installed in the installation locations for toner cartridges 611 (the installation units 614A through 614D), of which there are four, and considers that an error has been detected at the time point that it has found a location in which no cartridge is installed (in the step S26); while, if toner cartridges 611 are installed in all of the locations (YES in the step S24), it is considered that no error has been detected (in the step S27).

If the startup mode which is set is not the BW1 mode, then, since it is the Color mode or the BW4 mode, as described above, toner cartridges 611 must be installed in all of the four installation locations, so that, if no cartridge is installed in even one location, the processing proceeds for an error as described above. It should be understood that the above described check (in the step S23) as to whether or not a toner cartridge 611 is installed is performed based upon information from the engine control unit 5, in the same way as in the case of the step S22.

By doing as described above, the procedure of the step S20 is performed, and a decision is made as to whether or not an error related to “Install Toner” is occurring.

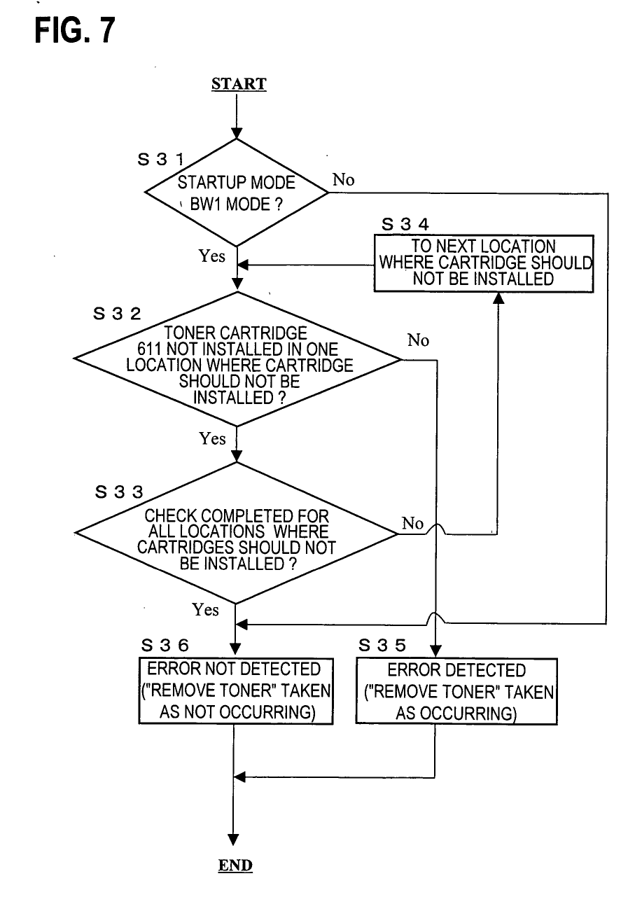

Next, FIG. 7 is a flow chart showing an example of the processing details for the step S30. Here, the CPU 42 performs a check as to whether or not “Remove Toner” is occurring, and, first, a decision is made as to whether the startup mode which is set at this time point is the BW1 mode or not (in a step S31). This error related to “Remove Toner” is an error which occurs only in the BW1 mode, and, if the startup mode is not the BW1 mode (NO in the step S31), then no error comes to be detected, and it is considered that “Remove Toner” is not occurring (in the step S36 and NO in the step S30).

If the startup mode which is set is the BW1 mode (YES in the step S31), then checks are made, in order for the three installation locations in which toner cartridges 611 must not be installed, as to whether toner cartridges 611 are not installed (in steps S32 and S34), and an error is considered to be detected (in the step S35 and YES in the step S30)at the time point (NO in the step S32) at which a location in which a cartridge is installed is found. In other words, “Remove Toner” is considered to be occurring. On the other hand, if no cartridges are installed in any of the above described three installation locations (YES in the step S33), then no error is detected, and it is considered that “Remove Toner” is not occurring (in the step S36 and NO in the step S30).

Since in the BW1 mode, as previously described, a toner cartridge 611 should only be installed in the installation unit 614D, accordingly, if a superfluous toner cartridge 611 is installed in any one of the installation units 614A through 614C, this error related to “Remove Toner” comes to occur. It should be understood that this toner cartridge 611 non-installation check (in the step S32) is performed based upon information from the engine control unit 5, as previously described.

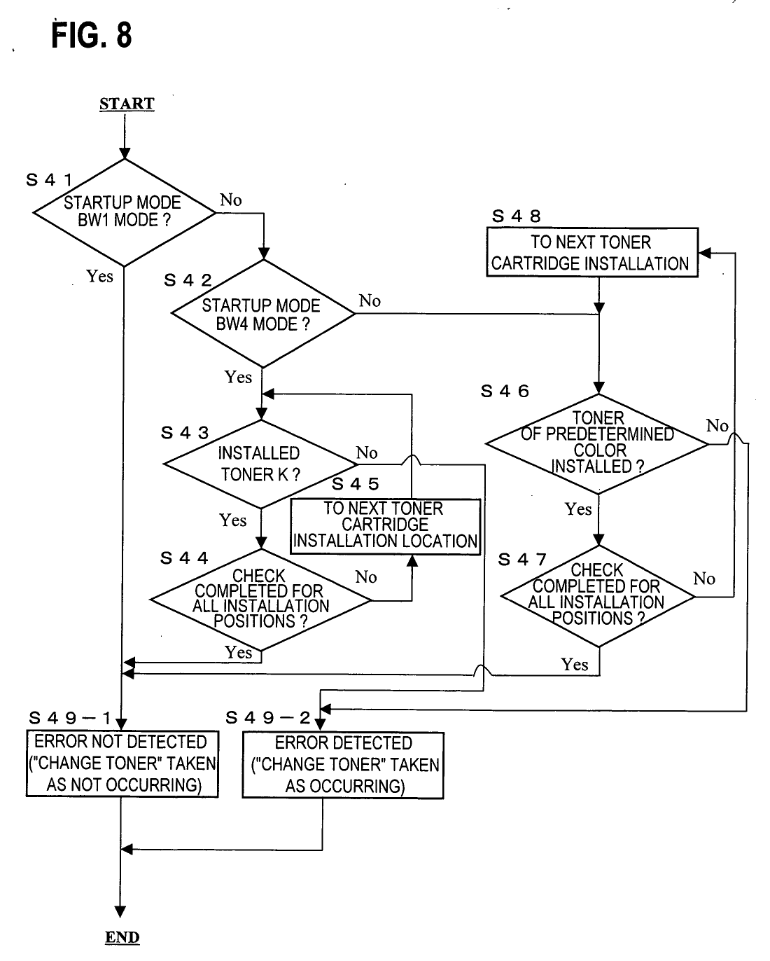

Next, FIG. 8 is a flow chart showing an example of the processing details for the step S40. Here, the CPU 42 performs a check as to whether or not “Change Toner” is occurring, and, first, a decision is made as to whether the startup mode which is set at this time point is the BW1 mode or not (in a step S41). If the startup mode is the BW1 mode (YES in the step S41), then it is considered that no error has been detected, and it is considered that “Change Toner” is not occurring (in the step S49-1 and NO in the step S40). If the current mode is the BW1 mode, then, at the time point that the flow of processing has reached this step S40, the installation state of the toner cartridges 611 which is appropriate for the BW1 mode has already been attained, so that it is not necessary to generate an error related to this “Change Toner” and to prompt exchange of the toner cartridge 611.

On the other hand, if the startup mode is not the BW1 mode (NO in the step S41), then a decision is made as to whether the startup mode is the BW4 mode or not (in a step S42). If the result thereof is that the startup mode is the BW4 mode (YES in the step S42), then, for the four installation locations, it is checked in order (in steps S43 and S45) as to whether the toner cartridge 611 which is installed is a K cartridge, and it is considered that an error has been detected (in the step S49-2 and YES in the step S40) at the time point (NO in the step S43) at which it has been found that a cartridge which is not a K cartridge is installed. In other words, it is considered that “Change Toner” is occurring. On the other hand, if the toner cartridges which are installed in all of the installation locations are K cartridges (YES in the step S44), then it is considered that no error is detected, and it is considered that “Change Toner” is not occurring (in the step S49-1 and NO in the step S40).

In the BW4 mode, as previously described, K toner cartridges 611 must be installed in all of the four installation locations, so that, if even one toner cartridge 611 other than a K toner cartridge is installed, this is considered as being an error. It should be understood that since, as described above, in this embodiment, only a K cartridge can be installed in the installation unit 614D, accordingly it would also be acceptable, in the steps S43 through S45, to check the three locations of the installation units 614A through 614C.

On the other hand if, in the step S42, the startup mode is not the BW4 mode (NO in the step S42), in other words if the startup mode is the Color mode, then a check is made (in steps S46 and S48), for the four installation locations in order, as to whether the toner cartridges 611 which are installed are ones of the predetermined colors, and it is considered that an error has been detected (in the step S49-2 and YES in the step S40) at the time point at which an installed cartridge has been found which is not one of the predetermined color (NO in the step S46). In other words, it is considered that Change Toner is occurring. On the other hand, if toner cartridges of the predetermined colors are installed in all of the installation locations (YES in a step S47), then it is considered that no error has been detected, and it is considered that “Change Toner” is not occurring (in the step S49-1 and NO in the step S40).

In the color mode, as previously described, it is necessary for toner cartridges of Y, M, C, and K to be installed in the respectively predetermined locations, and, if even one erroneous toner cartridge 611 is installed, an instruction is issued to exchange it for a toner cartridge 611 of the correct color. In concrete terms, since it is possible to install a K toner cartridge 611 in any of the locations, it is possible for the mistake to occur of a K cartridge being erroneously installed in any of the Y, M, or C installation locations. It should be understood that it would be acceptable to check the three installation unit locations 614A through 614C in the steps S46 through S48, since, as described above, in this embodiment, only a K cartridge can be installed in the installation unit 614D.

By doing as explained above, the procedure of the step S40 is performed, and it is decided whether or not an error related to “Change Toner” is occurring.

In this manner, in this embodiment, in the procedures as explained based upon from FIG. 4 to FIG. 8, the checking procedures for the installation state of the toner cartridges 611 are performed, and, in the case of an installation state of the toner cartridges 611 which is not in conformity with the startup mode, this is considered as being an error and a message is displayed; but this is only one example of the various procedures for making a check as to whether or not the installation state of the toner cartridges 611 is appropriate, and of the message which is displayed; a different procedure or message might be employed. For example, since the colors of the toner cartridges which must be installed in each of the installation locations are known in advance for each of the startup modes, it would also be possible to perform a check, in order for all of the four installation locations, as to whether they are in the correct state or not, and if there is any locations which are in an erroneous state, to output messages for all of these locations which are in an erroneous state all together. In this case, for example, a message such as “Insert yellow in installation unit 614A, and change the one in installation unit 614D to black” may be displayed, and, first, the installation unit 614A is shifted to the exchange position for its toner cartridge 611, and thereafter the installation unit 614D is shifted to the exchange position.

As explained above, with the printer 2 according to this embodiment, when the power source is turned ON or the like, appropriately, a check is made as to the conformity of the toner cartridges 611 which are installed with the startup mode which is set, and, in the case of non-conformity, a message is displayed to the user. And printing operation is not performed, until the startup mode and the state of the toner cartridges 611 which are installed are in conformity. Accordingly, it no longer can happened that printing can be performed with inappropriate toner cartridges 611, and it is possible always to perform correct printing with the appropriate toner cartridges 611. Due to this, along with it being possible to prevent the useless consumption of paper and toner, it is also possible to ensure that the user can perform operation for executing printing with peace of mind.

Furthermore since, if the state of the toner cartridges 611 is not correct, information about the toner cartridges 611 for which installation or the like must be performed is displayed, and moreover the installation locations for the toner cartridges 611 which must be worked upon are automatically shifted to the exchange position, accordingly it is possible for the user, without making any mistakes, to bring about an appropriate state for the toner cartridges 611 in a simple and easy manner.

It should be understood that although with the printer 2, in this embodiment, as described above, three startup modes were provided, the present invention could also be applied to a printer which was provided with different startup modes.

Furthermore although, in the embodiment, the image forming device was a printer, the present invention may also be applied to an image forming device of a different type, such as a photocopier or a facsimile machine or the like.

The range of protection of the present invention is not limited by the above described embodiment; it covers any invention which comes within the scope of the Patent Claims below, as well as equivalents thereof.

What is claimed is:

1. An image forming device to which development units containing toner are removably installed, and which performs image forming using the toner contained in said development units, wherein
said image forming device can operate in a plurality of startup modes, in each of which a respective installation condition for the development units, according to at least the toner colors and numbers of said development units which are installed,is determined, and
the image forming device comprises a control unit which outputs a command to display a message to a user of said image forming device, if the installation condition for said development units which is determined for said startup mode which is set, and the installation state of said development units which are installed, are different.

2. The image forming device according to claim 1, further comprising a display portion, wherein said display portion displays said message according to said display command.

3. The image forming device according to claim 1 or claim 2, wherein said message to said user prompts the user to perform a task to be performed by the user with regard to attachment or removal of said development units.

4. The image forming device according to any of claim 1 through claim 3, wherein if the installation condition for said development units and said installation state thereof are different, an installation location of said development unit for which the task is to be performed by said user is shifted to an exchange position of said development unit.

5. The image forming device according to any of claim 1 through claim 4, wherein if the installation condition for said development units and said installation state thereof are different, said image forming procedure is not performed.

6. The image forming device according to any of claim 1 through claim 5, comprising said startup mode in which said installation condition is that a plurality of said development units containing black toner are installed.

7. The image forming device according to any of claim 1 through claim 5, comprising:
said startup mode in which said installation condition is that one each of said development units, respectively containing toner of one of a plurality of colors used for said image forming in color, is installed;
said startup mode in which said installation condition is that a plurality of said development units containing black toner are installed; and
said startup mode in which said installation condition is that one of said development units which contains black toner is installed.
